(19) United States
(12) Patent Application Publication
(10) Pub. No.: US 2014/0101053 A1
(43) Pub. Date: Apr. 10, 2014

(54) Aggregation and Billing for Metering

(71) Applicant: MICROSOFT CORPORATION, Redmond, WA (US)

(72) Inventor: George Danezis, Cambridge (GB)

(73) Assignee: MICROSOFT CORPORATION, Redmond, WA (US)

(21) Appl. No.: 13/645,228

(22) Filed: Oct. 4, 2012

(51) Int. Cl. G06Q 50/00

(52) U.S. Cl. 705/63

(57) ABSTRACT

A protocol to provide security, privacy and robustness in the context of distributed metering statistics is described herein. Blinded readings may be produced by a subset of meters. A service provider receives a subset of blinded readings and calculates to uncover their weighted sum. To achieve this, a de-blinding value may also be requested by the service provider from a set of aggregation authorities. The service provider may determine the aggregate statistics based at least in part on the blinded readings and the de-blinding values, while the privacy of individual readings is preserved

### BACKGROUND

The use of aggregate statistics is at the heart of fine tuning modern business and government operations. While the statistics themselves have a minimal impact on individual privacy, conventional ways for collating them involve large scale collection of fine grained private data, which raises privacy concerns.

An example of this type of aggregate statistics is information collected by smart meters for electrical metering. Smart meters can provide readings on electricity usage to a service provider for a defined group of meters, such as for usage at geographic location on a fine grained interval. However, some of the readings from the meters in these groups may be missing at the service provider. Computing aggregate values from multiple meters with missing meter readings may be inefficient for the aggregation operations of conventional aggregation systems.

### SUMMARY

Computing devices may be configured with a setup module and an aggregation module. The setup module may be configured to generate public keys for a plurality of meters and aggregators. The setup module may then provide the public keys of the plurality of meters to the plurality of aggregators and the public keys of the plurality of aggregators to the plurality of meters. The aggregation module may be configured to receive blinded readings from one or more of the meters and a plurality of de-blinding values corresponding to the plurality of aggregators. Each de-blinding value may be a sum of one or more representations of keys corresponding to the one or more meters. The aggregation module then may subtract an aggregation of the de-blinding values from an aggregation of the blinded readings to recover an aggregated reading. The de-blinding values corresponding to the plurality of the aggregators may also be associated with a noise value.

These computing devices may also include a billing module configured to receive a blinded reading from one of the meters and a plurality of de-blinding values corresponding to the plurality of aggregators. Each de-blinding value may be a representation of a key corresponding to the meter. The billing module may subtract an aggregation of the de-blinding values from the blinded reading to recover a reading of the meter and utilize the reading for billing.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an overview of example setup operations, in accordance with various embodiments.

FIG. 2 illustrates an overview of example aggregation operations, in accordance with various embodiments.

FIG. 3 illustrates example computing devices, in accordance with various embodiments.

FIG. 4 illustrates an example process for an aggregation scheme, in accordance with various embodiments.

FIG. 5 illustrates an example process for setup operations, in accordance with various embodiments.

FIG. 6 illustrates an example process for aggregation operations, in accordance with various embodiments.

FIG. 7 illustrates an example process for billing operations, in accordance with various embodiments.

### DETAILED DESCRIPTION

### Overview

This disclosure describes, in part, techniques for improving privacy of data through data blinding and aggregation. In various embodiments, the techniques provide a scheme for aggregation that is tolerant to missing values from requested meter readings. For example, a requesting device may identify one or more meters from which one or more requested readings were not received and other meters from which the requested readings were received. Because each received reading from a corresponding meter is blinded by combining its meter reading with a sum of hashes of corresponding secrets from an aggregate authority, the requesting device then requests the sum of the hashed secrets of the meters that responded from each aggregator of the aggregating authority. The requesting device may de-blind a sum of the received blinded readings by subtraction using the sum of the de-blinding values from the aggregators. Thus, the aggregate meter readings may be determined without doing complex decoding or decrypting of the readings (e.g., no public key operations, such as encryption with a public key or decryption with a secret key, or threshold decryption), and the determination of the aggregate meter readings may be tolerant of the missing meter readings. The aggregate meter readings may be short blinded readings of the order of 32 bits per reading. In various embodiments, the protocol provides increased privacy by adding noise to the de-blinding value.

As used herein, “blinding” and “de-blinding” data refers, respectively, to the addition and subtraction of representations of keys, such as hashes of session keys, from that data. The keys may be used in other contexts for encryption and decryption; blinding and de-blinding, however, do not involve encrypting or decrypting the data. Rather, as stated, they only involving summing the data with the representations of keys and reducing the representations of keys from blinded data. The use of representations of keys in such summations and reductions provides the data with a measure of privacy while avoiding the overhead typically incurred by public key encryption and decryption techniques because the additions and subtractions are hidden if the keys are unknown.

In some embodiments, the protocol may be used in smart-metering. Smart meters collect information about household or industrial electricity usage or generation. For example, the information may be collected at a granularity of any desired time value or time period. Timely statistics may be used to support the business processes of energy distributors, providers and generators. Distributors, for instance, may use statistics about the peak loads that particular lines may be subject to, while service providers may need to know the exact consumption of their customer base for every settlement period. The entities may require statistics to support the development of their future services or financial forecasting at different geographic or demographic levels. The protocol allows the same readings from a smart meter to be used by different entities for statistics as needed. Moreover, the smart meters are agnostic as to the computations on the readings (e.g., they do not have to be re-configured for different computations and the same readings may be used for any computations that are thought off after the reading was produced). Furthermore, failing meters or unreliable networks do not impede the aggregation the readings collected. Privacy of individual customer energy usage is protected with this protocol.

In some embodiments, the protocol may be used in epidemiology for biological diseases as well as malicious computer software (e.g., malware). An increasingly physically and virtually connected world presents challenges when it comes to monitoring the spread of real-world diseases as well as virtual malware. Alarm mechanisms may track the prevalence of any kind of diseases or malware infections and can very rapidly detect abnormal trends. However, the data that monitors those threats is often held by private entities, be it private hospitals or corporations with large private networks. These private entities are reluctant to provide raw numbers to others for fear of disclosing sensitive data. Some embodiments of the protocol may be used to aggregate rates of incidence of specific diseases or malware infections without disclosing any information about the specific incidence at a particular place or institution. More fine-grained epidemiology studies may use statistics that are aggregated locally to track the spread of an infection due to biological diseases or computer malware.

In some embodiments, the protocol may be used with telecommunication networks. Providers of the telecommunication networks may wish, for example, to charge for transporting data per byte, without disclosing their topology, or which specific router did the transport. Some embodiments of the aggregation protocol may be used by the telecommunication networks to enable aggregate statistics and controlled research of the networks to be performed while safeguarding the anonymity of the users.

In some embodiments, the protocol may be applicable in any type of domain that utilizes aggregated statistics collected for analysis. The aggregated statistics include weighted sums of secret readings. For example, the aggregated statistics may be applicable to statistics across a plurality of meters or to billing associated with the readings of a single meter.

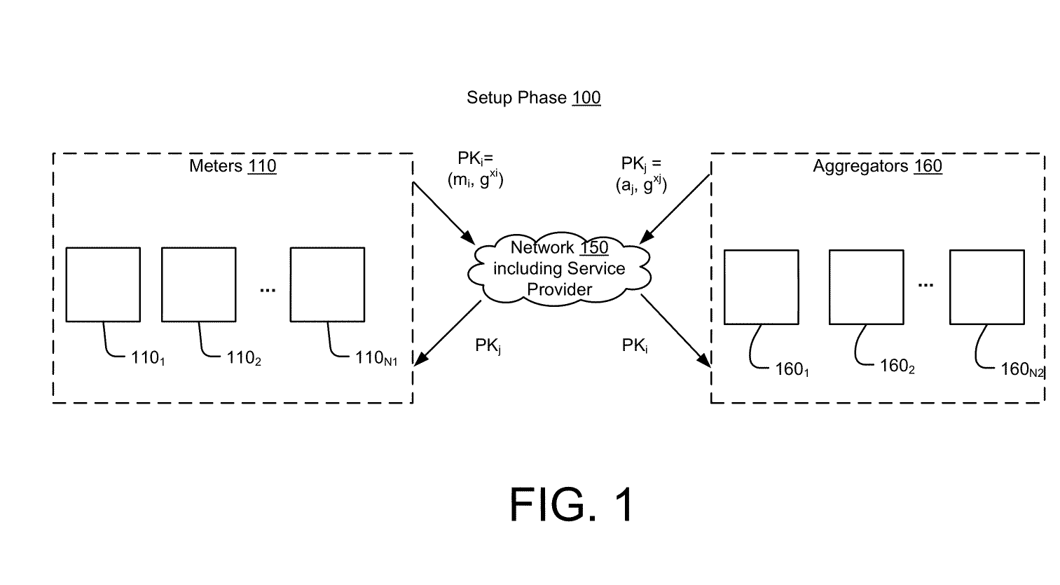

FIG. 1 shows an overview of example setup operation 100, in accordance with various embodiments. As illustrated in FIG. 1, the setup operation 100 may utilize a network including a service provider 150. The service provider orchestrates the communication of secrets, such as encryption keys, between a set of meters 110 and a set of aggregators 160. In some embodiments, the meters and aggregators do not communicate with each other directly.

In some embodiments, meters 110 may include a plurality of meters 110₁, 110₂ . . . 110_{N1}. The meters 110 may be all or some of the meters in a geographical area, building complex, etc. accessible by a distributor, service provider and/or generator. Each meter 110₁, 110₂ . . . 110_{N1} may be individually coupled with every aggregator 160₁, 160₂ . . . 160_{N1} in the set of aggregators 160 for generating secrets between each meter 110₁, 110₂ . . . 110_{N1} and each aggregator 160₁, 160₂ . . . 160_{N1}. Any method that ensures each meter/aggregator pair share a secret key maybe used. In some embodiments, the secret may be a private/public key pair between one of the meters and one of the aggregators. In some embodiments, the secret may be a session key or a public key. Any encryption method may be used as the secret.

In some embodiments, each meter 110₁, 110₂ . . . 110_{N1} and each aggregator 160₁, 160₂ . . . 160_{N1} are communicatively coupled to the service provider via a network 150. The network 150 may include wide area networks (WANs), local area networks (LANs), or the Internet. Also, the network 150 may be public, private, or include both public and private networks. Further, the network 150 may be wired, wireless, or include both wired and wireless networks. The network 150 may utilize any one or more protocols for communication, such as the Internet Protocol (IP), other packet based protocols, carrier sense multiple access with collision avoidance (CSMA/CA), or other protocols. Additionally, the network 150 may include any number of intermediary devices, such as routers, base stations, access points, firewalls, or gateway devices. The network 150 may ensure a secure mechanism for the transmission of the secret. Any way to encrypt or encode may be used to protect the transmission of the secret. In some embodiments, a certificate chain may be used. In other embodiments, factory initialization may be used.

In some embodiments, the set of aggregators 160 may include individual aggregators 160₁, 160₂ . . . 160_{N1}. The set of aggregators 160 may be all or some of the aggregators in an authority accessible by the distributor, service provider and/or generator. Each aggregator 160₁, 160₂ . . . 160_{N1} may be individually coupled with every meter in the set of meters 110 for generating secrets between each meter 110₁, 110₂ . . . 110_{N1} and each aggregator 160₁, 160₂ . . . 160_{N1}. In some embodiments, the set of aggregators may be a single trusted authority.

In various embodiments, the key of each meter 110₁, 110₂ . . . 110_{N1} is provided to every one of the aggregators 160 and the key of each aggregator 160₁, 160₂ . . . 160_{N1} is provided to all the meters 110. In some embodiments, the setup phase is performed once per meter provided that the aggregators 160 are stable. If there are new meters added, the setup phase is performed only for the new meters, and the protocol may provide the keys of all the new meters to all the aggregators 160.

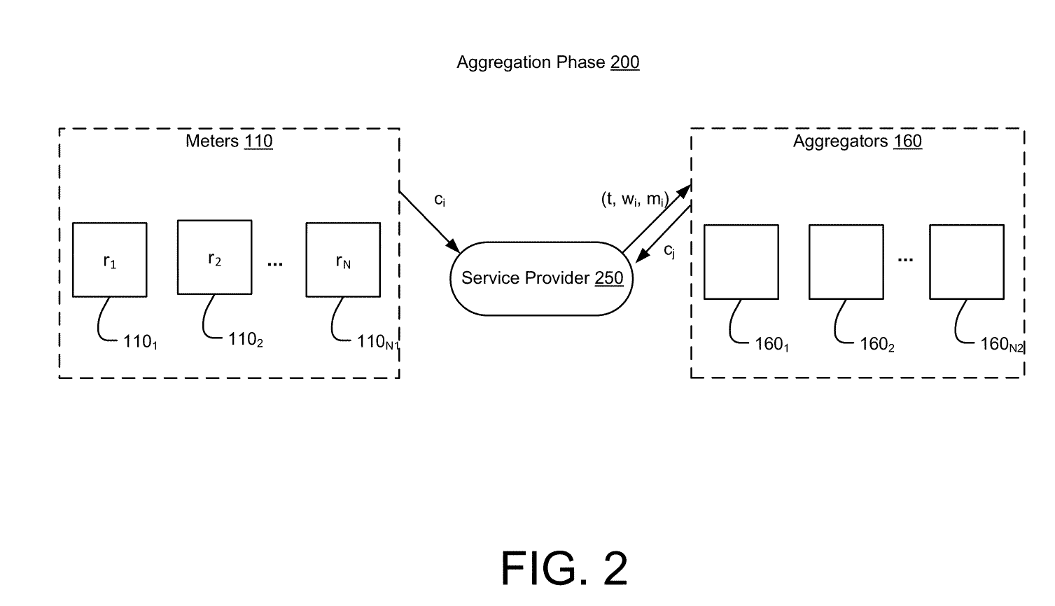

FIG. 2 illustrates an overview of example aggregation operations 200, in accordance with various embodiments. As illustrated in FIG. 2, a service provider 250 may communicate with and may utilize the meters 110 and aggregators 160 in performing the aggregation operations for improving aggregation of data. In some embodiments, three types of entities are involved in the aggregation of data. A set of meters 110 to record and report readings rᵢ, a set of aggregators 160 to facilitate private aggregation, and a service provider 250 to learn the aggregate value T=Σᵢwᵢ·rᵢ, which is the sum of the weighted readings of the set of i meters, where “i” is an integer and “wᵢ” is a weight value. The protocol may compute T without revealing any rᵢ to any single entity besides the meter that generated it. In other words, nothing is revealed about rᵢ that is not revealed by T.

In some embodiments, a service provider 250 may utilize the aggregation operations to obtain information regarding a process or situation. For example, the service provider 250 may request statistical information from a set or subset of meters for analysis in order to improve an operation or process. The service provider 250 may request aggregate statistics, which may involve one or more customers. In various embodiments, the service provider 250 may use the requested information to provide improved service for the customers. The service provider 250 may use the aggregate statistic for any purpose. To ensure the privacy of the individual customers, the service provider 250 will not be able to see any fine grained reading identifiable to any particular customer. The requested statistical information is received by the service provider 250 as blinded readings.

The blinded readings are generated by one or more of the meters 110 and may include an individual customer's fine grain usage. To ensure the privacy of the customer, the readings and statistics obtained by the meter needs to be shielded from everyone else during this operation. In some embodiments, the readings are blinded by at least the shared keys between the meters 110 and the aggregators 160. The shared keys may be the result of a public key exchange or may have been established using any other secure method. The blinded reading may be a ciphertext. In some cases the blinded readings from the meters 110 may be encrypted under the key of the service provider 250, so that they cannot be observed in transit.

The service provider 250 may receive some or all of the requested blinded readings from a subset of meters or all the meters 110, respectively. The service provider 250 then requests from the aggregators 160 a de-blinding value that allows the aggregator to decode the aggregate value of the subset of all of the meters. Actual readings of the meters do not need to be transmitted to any aggregators. This operation provides additional privacy for the individual customers as the service provider 250 only obtains the aggregate reading and not individual readings. In some embodiments, noise may be added by the aggregators 160 to the de-blinding value to provide additional privacy. The de-blinding value is used by the service provider 250 to obtain the aggregate values of the set or subset of meters without using public key operations and using only modular integer arithmetic.

In some embodiments, this scheme, which may be utilized as a cryptographic protocol, may compute a linear weighted sum of customer private values. For example, if all the weights are one, then the protocol is a straightforward private summation protocol. In other cases where the weights are different allowing a variety of statistics or even billing to be privately implemented. In some embodiments, the private aggregation may be aided by a set of aggregators in the trusted authority. The set of aggregators may be used to assist with the generation of keys and to provide de-blinding values to the service provider 250 and may be run as cloud services.

In various embodiments, these aggregators 160 are oblivious as to the result of the aggregation, but may be used to audit the types of aggregation queries that were submitted by the service provider 250, and check them against a privacy policy. For example, trusted authorities may be used to audit and compare the queries against the privacy policy. The privacy policy may include dividing queries into ones that are for regulated duties and other duties. Queries for regulated duties may be associated with basic statistics to establish the consumption per-supplier, per-region, for monthly billing, etc. Queries for other duties may include market research, etc. In some embodiments of the privacy policy, queries relating to regulated duties may be performed once every predetermined time period, such as 30 minutes, for the statistics and noise may optionally be added. In other embodiments, different time periods and/or noise may or may not be added to the statistics. Another exemplary policy may limit the number of queries that may be executed within a predetermined time period and noise is added to the result of such queries.

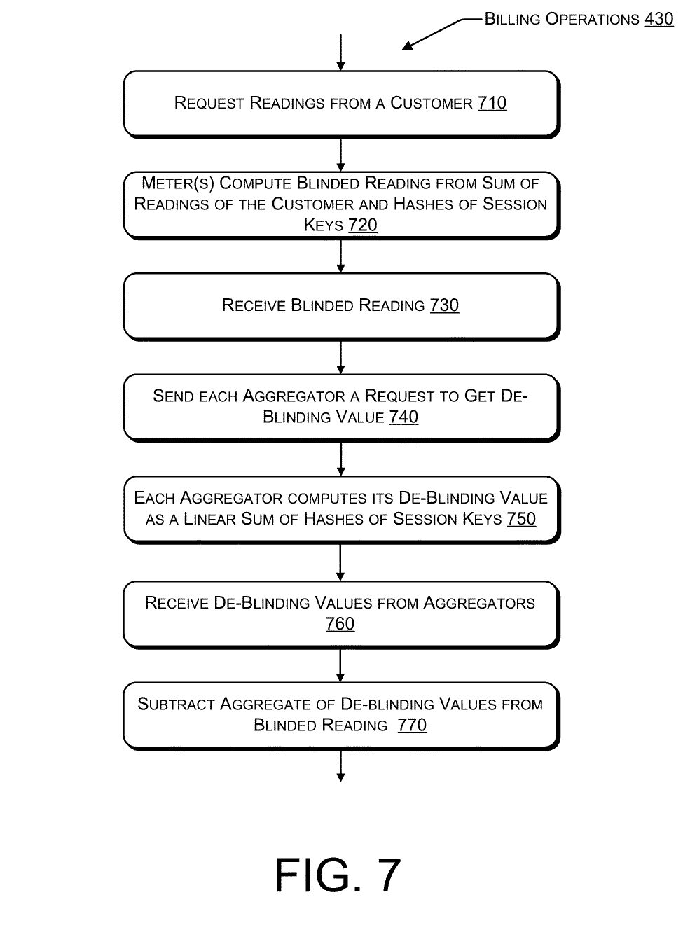

In some embodiments, the scheme provides an aggregation protocol that allows for billing using a linear policy as described below in FIG. 7. In further embodiments, the aggregation provides statistics across meters as well as across time. The aggregate statistics can further be manipulated where statistical analysis may be performed such as determining a mean and/or variance of the aggregate statistics. In some embodiments, the meters 110 additionally output a blinded reading for rᵢ² when using the variance.

### Example Electronic Device

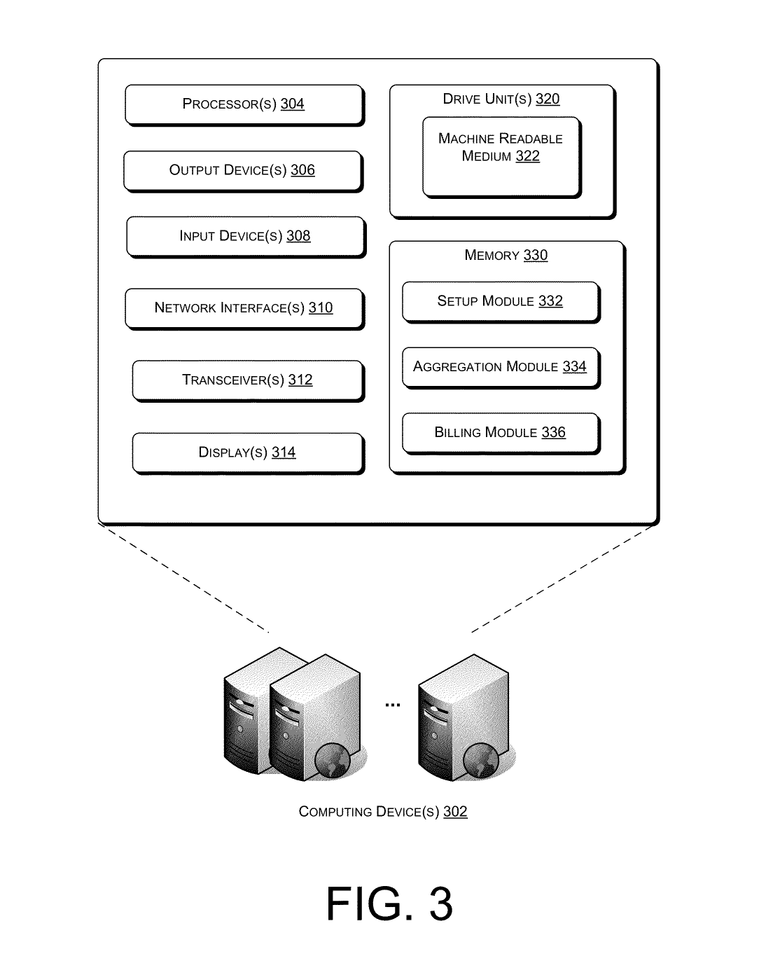

FIG. 3 illustrates an example computing device configured with functionality for performing various embodiments of the aggregation scheme. As illustrated, one or more computing devices 302 (referred to as “computing device 302”) may include processor(s) 304, network interface(s) 310, a display 314, transceiver(s) 312, output device(s) 306, input device(s) 308, drive unit(s) 320, and memory 330. The drive unit(s) 320 may include one or more machine readable media 322. The memory 330 may include a setup module 332, an aggregation module 334, and a billing module 336.

In various embodiments, the computing device 302 may be any sort of computing device or computing devices. For example, the computing device 302 may be or include a personal computer (PC), a laptop computer, a server or server farm, a mainframe, a tablet computer, a work station, a telecommunication device, a personal digital assistant (PDA), a media player, a media center device, a personal video recorder (PVR), a television, or any other sort of device or devices. In one implementation, the computing device 302 represents a plurality of computing devices working in communication, such as a cloud computing network of nodes. When implemented on multiple computing devices (e.g., in a cloud computing system, etc.), the computing device 302 may distribute the modules and data among the multiple devices. In some implementations, the computing device 302 represents one or more virtual machines implemented on one or more computing devices.

In some implementations, the network 150 may connect multiple devices represented by the computing device 302, as mentioned above. Also, such a network may connect the computing device 302 to other devices. The network 150 may be any type of networks, such as wide area networks (WANs), local area networks (LANs), or the Internet. Also, the network 150 may be public, private, or include both public and private networks. Further, the network 150 may be wired, wireless, or include both wired and wireless networks. The network 150 may utilize any one or more protocols for communication, such as the Internet Protocol (IP), other packet based protocols, carrier sense multiple access with collision avoidance (CSMA/CA), or other protocols. Additionally, the network 150 may include any number of intermediary devices, such as routers, base stations, access points, firewalls, or gateway devices.

In various embodiments, processor(s) 304 may include any one or more central processing units, graphic processing units, or any other sort of processing unit.

In various embodiments, the network interface(s) 310 may be any sort of interfaces. The network interface(s) 310 may support both wired and wireless connections to networks, such as cellular networks, radio, Wi-Fi networks, short range networks (e.g., Bluetooth, IR, and so forth). Network interfaces 310 may include any one or more of a WAN interface or a LAN interface.

In various embodiments, the display 314 is a liquid crystal display or a cathode ray tube (CRT). Display 314 may also be a touch-sensitive display screen, and can then also act as an input device or keypad, such as for providing a soft-key keyboard, navigation buttons, or the like.

In some embodiments, the transceiver(s) 312 may include any sort of transceivers known in the art. The transceiver(s) 312 may include a radio interface. The transceiver(s) 312 may facilitate wired or wireless connectivity between the computing device 302 and other devices.

In some embodiments, the output device(s) 306 may include any sort of output devices known in the art, such as a display (already described as display 314), speakers, a vibrating mechanism, or a tactile feedback mechanism. Output device(s) 306 also may include ports for one or more peripheral devices, such as headphones, peripheral speakers, or a peripheral display.

In various embodiments, input device(s) 308 may include any sort of input devices known in the art. For example, input devices 308 may include a microphone, a camera, a keyboard/keypad, or a touch-sensitive display (such as the touch-sensitive display screen described above). A microphone may accept voice commands as input. A camera may capture an image or gesture as input. A keyboard/keypad may be a multi-key keyboard (such as a conventional QWERTY keyboard) or one or more other types of keys or buttons, and may also include a joystick-like controller and/or designated navigation buttons, or the like.

The machine readable media 322 may store one or more sets of instructions (e.g., software) embodying any one or more of the methodologies or functions described herein. The instructions may also reside, completely or at least partially, within the memory 330 and within the processor(s) 304 during execution thereof by the computing device 302. The memory 330 and the processor(s) 304 also may constitute the machine readable media 322.

In various embodiments, memory 330 (and other memories described throughout) is an example of computer-readable storage media and may include volatile and nonvolatile memory. Thus, the memory 330 may include, but is not limited to, RAM, ROM, EEPROM, flash memory, or other memory technology, miniature hard drive, memory card, optical storage (e.g., CD, DVD), magnetic cassettes, magnetic tape, magnetic disk storage (e.g., floppy disk, hard drives, etc.) or other magnetic storage devices, or any other medium which can be used to store media items or applications and data which can be accessed by the computing device 302. Memory 330 can also be described as computer readable storage media and may include removable and non-removable media implemented in any method or technology for storage of information, such as computer readable instructions, data structures, program modules, or other data.

The memory 330 may be used to store any number of functional components that are executable on the processor(s) 304, as well as data and content items that are rendered by the computing device 302. Thus, the memory 330 may, for example, store an operating system. In various embodiments, the setup module 332, aggregation module 334, and billing module 336 may be stored in memory 330.

### Aggregation Scheme

In some embodiments, the aggregation scheme allows for the computation of a weighted sum of readings from a single entity. This scheme may provide for privacy friendly billing, as well as more complex applications like the private computations of Discrete Cosine Transform or Discrete Wavelet Transforms coefficients on the private data. In various embodiments, no public key operations are used during the aggregation operation and no additional communication overheads are added on meters. For example, the operations may tolerate any number of meter failures with no additional impact on the quality of the aggregate result. In other words, despite unreliability and failures, aggregated statistics such as averages and variances may be collected extremely efficiently at a very large scale without compromising privacy.

In further embodiments, the setup module 332 may determine and store the secrets of the meters 110 and aggregators 160 for blinding and de-blinding. In some embodiments, each meter and each aggregator generates a public/secret key pair of a Diffie-Hellman crypto system. Any type of encryption encoding strategy may be used. After the keys are generated, a trusted authority then distributes the keys to the relevant parties, e.g. all meter public keys are provided to the aggregators, and all aggregator public keys are provided to the meters.

In some embodiments of the setup module 332, the set of all meters 110 is denoted by M and the set of all aggregators 160 is denoted by A. Also, mᵢ represent the i-th meter of all meters 110, and aⱼ represent the j-th aggregator of all the aggregators 160. Each of these entities may generate a public/private key pair using the generateKey procedure, upon which they generate and store a secret value x, and publish the corresponding public key y=g^{x}, where g is the description of a mathematical group. Each entity may also be seeded with the public keys of other entities to derive a shared key such as a Diffie-Hellman shared key through the procedure addKey, as S_{n′}=y_{n′}^{x}=g^{x}^{_{n′}}^{x}, where n is a name and l is the length of the key.

procedure generateKey(l,g,n): (1)

x←random(l) (2)

y=g^{x} (3)

store x (4)

return(n,y) (5)

procedure addKey(l,n,(n′,y_{n′})): (6)

retrieve x (7)

S_{n′}=y_{n′}^{x} (8)

store S_{n′} (9)

In some embodiments, a trusted authority coordinates the setup module 332 by executing the initialize procedure. It may instruct each meter and aggregator to generate a public/private key pair, and then seeds all meters 110 with the public keys of all aggregators 160, and vice-versa all aggregators 160 with the public keys of all meters 110. As a result meters 110 and aggregators 160 can derive a pairwise shared key:

procedure initialize(l,g,M,A): (10)

for aᵢ in A: (11)

[symbol]

y_{j′}=aⱼ.generateKey(l,g,aⱼ) (12)

for mᵢ in M: (13)

[symbol]

yᵢ=mᵢ.generateKey(l,g,mᵢ) (14)

for aⱼ in A: (15)

mᵢ.addKey(l,mᵢ,(aⱼ,yⱼ)) (16)

aⱼ.addKey(l,aⱼ,(mᵢ,yᵢ)) (17)

In some embodiments, the setup module 332 may result in all meters 110 being seeded with the valid keys of all aggregators 160 and vice versa. Any secure mechanism, including a certificate chain, an auditing mechanism or factory initialization can be used, but may have different system's ramifications. The initialization phase only needs to be performed once per meter, given a stable set of aggregators 160. On the other hand, aggregators 160 may be seeded with the keys of all new meters.

In various embodiments, an aggregation module 334 may include protocol to aggregate statistics. The aggregation module 334 may be executed after the system has been initialized with the setup module 332. Meters 110 generate a number of different values of readings over time. In some embodiments, any specific reading may be characterized by a time t. Other public data may also be used based at least in part on consumption or production register, the identifier of the sensor if multiple sensors are used in a home, etc. The service provider 250 aggregates readings rᵢ of type t from all meters and compute the weighted sum T=Σᵢwᵢ·rᵢ.

First, the service provider 250 requests a blinded reading cᵢ from each meter by executing getReading. The blinded reading cᵢ is computed by each meter as the sum of its reading rᵢ and all session keys shared with the aggregators 160. Session keys are generated by hashing the shared keys with the identifier of the reading sought. The ciphertext cᵢ is a simple 32 bit integer, and the only computation involved in producing it on the meter is the application of a hash function and simple integer arithmetic.

procedure getReading(t): (18)

retrieve rₜ,∀jεA.Sⱼ (19)

cₜ=rₜ+Σ_{∀S}_{ⱼ}Hash(t|Sⱼ)mod 2³² (20)

return cₜ (21)

The service provider 250 may request readings from all meters 110, but some of the readings may fail to arrive due to meter malfunction, network unavailability, latency or the like. The service provider 250 gathers the identities of the meters that have responded in a subset M′ and sends each aggregator 160₁, 160₂ . . . 160_{N1} a request getOpenings to facilitate the aggregation of the values for readings type t from the meters in M′ using weights wᵢ. Each aggregator then computes the linear sum of the weights and session keys shared with each meter for the reading types t, and adds to it some noise DP_{ε}. The distribution of the noise is chosen to offer differential privacy on the basis of the sensitivity of a single reading being the maximum of the weighted readings, max(r·w). The result of this sum, a single 32 bit number, is returned to the service—the actual readings cᵢ may not be transmitted to the aggregators to provide additional privacy protection.

procedure getOpenings(t, w̅ᵢ,M′): (22)

retrieve ∀iεM′.Sᵢ (23)

s=Σ_{∀S}_{ᵢ}_{εM′}wᵢ·Hash(t|Sᵢ)mod 2³² (24)

noise←DP_{ε} (25)

returns+noise mod 2³² (26)

In some embodiments, the service provider 250 sums the weighted blinded readings. Then, the sum of the responses from the aggregators is subtracted from the sum of the weighted blinded readings. The result is the aggregate value T, as illustrated in:

procedure aggregateWeightedSubset(t, w̅ᵢ,M′): (27)

for mᵢ in M′: (28)

cᵢ=mᵢ.getReading(t) (29)

for aⱼ in A: (30)

c′ⱼ=aⱼ.getOpenings(t, w̅ᵢ,M′) (31)

T=Σₘ_{ᵢ}_{εM′}wᵢ^{·c}ᵢ−Σₐ_{ⱼ}_{εA}c′ⱼ mod 2³² (32)

return T (33)

The full aggregation process, initiated by the service provider 250, is outlined in procedure aggregateWeightedSubset. In some embodiments, it utilizes only 2·|M′|·|A| hash function applications, distributed across all meters 110 and aggregators 160, no public key operations, and only integer arithmetic at the service provider 250.

In some embodiments, at least a single meter is honest, and a single aggregator is honest. Furthermore, the trusted set-up has ensured that the two honest parties are aware of each other's public keys and thus share a symmetric key, and the Diffie-Hellman assumption holds in the chosen of g. Under these conditions an adversary that controls the service, all other meters and all other aggregators can only learn a differentially private view of the honest reading with security parameter ε. In practice, this means that if the honest aggregator limits the number of aggregation requests for any reading or to any meter t to k, the above algorithm offers differential privacy with security parameter k·ε.

If more than one meter, and at least a single aggregator, are honest, the adversary learns nothing about the partition of the resulting sum between the different meter readings. The aggregators are oblivious to the readings or even the resulting weighted sum: they do not even need to see the ciphertext to execute their part of the protocol. Yet, the aggregators can audit the privacy compliance of aggregation queries. In some embodiments, the audit allows the aggregators to provide a list of queries performed on one or more meters to the owner of the meter. The owner then may use the list as desired. For example, the owner may complain to a regulator incase the nature of the queries or their frequency violate a contract or policy.

In various embodiments, traditional encryption or signature schemes may be used to protect the confidentiality and integrity of all communications between meters, service providers, and aggregators from third parties. For example, additional encryption and or encoding may be used for the transmission of any of the information between the meters, aggregators and services.

In various embodiments, linear billing may be performed in a billing module 336 in the memory 330 of the computing device 302. A service provider 250 may wish to do simple time-of-use billing for a specific set of meter readings. A bill B is calculated over a number of different reading types tₖ all belonging to a single customer, by applying to each reading a time dependent rate wₖ. This can be achieved as follows:

procedure getBillOpenings( t̅ₖ, w̅ₖ,mᵢ): (34)

retrieve Sᵢ (35)

returns=Σ_{∀k}wₖ·Hash(tₖ|Sᵢ)mod 2³² (36)

procedure linearBilling( t̅ₖ, w̅ₖ,mᵢ): (37)

for t in t̅ₖ:cₖ=mᵢ.getReading(t) (38)

for aⱼ in A: (39)

c′ⱼ=aᵢ.getBillOpenings( t̅ₖ, w̅ₖ,mᵢ) (40)

Bᵢ=Σₖwₖ·cₖ−Σₐ_{ⱼ}_{εA}C′ⱼ mod 2³² (41)

return Bᵢ (42)

In some embodiments, no noise is added to the readings, since bills needs to be accurate. The security guarantee is that the service only learns what can be deduced from the final bill.

In some instances, the computing device 302 may have features or functionality in addition to those that FIG. 3 illustrates. For example, the computing device 302 may also include additional data storage devices (removable and/or non-removable) such as, for example, magnetic disks, optical disks, or tape. The additional data storage media may include volatile and nonvolatile, removable and non-removable media implemented in any method or technology for storage of information, such as computer readable instructions, data structures, program modules, or other data. In addition, some or all of the functionality described as residing within the computing device 302 may reside remotely from the computing device 302. In such implementations, the computing device 302 may utilize the network interface(s) 310 to communicate with and utilize this functionality.

Various instructions, methods and techniques described herein may be considered in the general context of computer-executable instructions, such as program modules, executed by one or more computers or other devices. Generally, program modules include routines, programs, objects, components, data structures, etc. for performing particular tasks or implement particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on or transmitted across some form of computer readable media.

### Example Processes

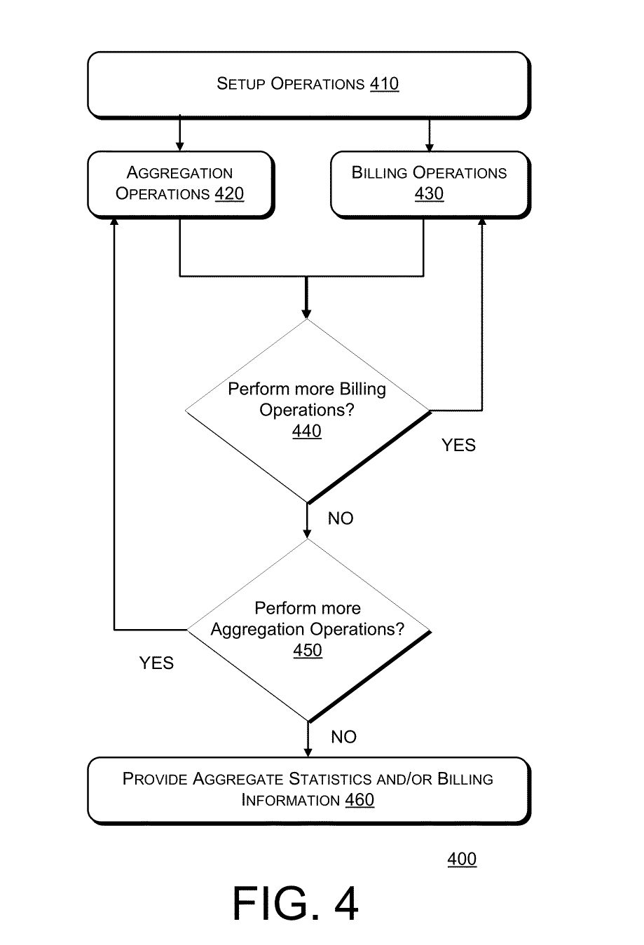

FIGS. 4-7 illustrate operations of an embodiment of the protocol including setting up, aggregating, and billing. These operations are illustrated in individual blocks and summarized with reference to those blocks. The operations may be performed in hardware, or as processor-executable instructions (software or firmware) that may be executed by one or more processor(s) 304. Further, these operations may, but need not necessarily, be implemented using the arrangement of FIGS. 1-3. Consequently, by way of explanation, and not limitation, the method is described in the context of FIGS. 1-3.

FIG. 4 illustrates an example process 400 for an aggregation scheme, in accordance with various embodiments. This process (as well as each process described herein) is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processor(s) 304, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

The process 400 includes performing, by a computing device 302 such as a service provider 250, setup operations 410 of an embodiment of the aggregation protocol. The setup operations 410 configure the system to be able to perform aggregation operations 420 and billing operations 430 without needing to re-perform the setup operations 410. For example, during the setup operations 410, shared secrets between all the meters 110 and aggregators 160 such as the keys maybe generated and stored.

At 420, the computing device 302 may request and determine the desired aggregate statistics that it would like to receive. To ensure privacy, the aggregate statistics is obtained; however, the service provider 250 and aggregators 160 do not have access to the individual readings of the individual meters 110₁, 110₂ . . . 110_{N1}.

At 430, the computing device 302 may perform billing operations. The billing operations determine the amount of usage based on the metering. The metering information received is aggregated and blinded such that after de-blinding using the value from the trusted authority or aggregators, the service provider 250 may determined the bill. Using this information, the service provider 250 may securely provide a bill to a client for the amount of usage. Because the values of the actual readings are blinded, the service cannot see the fine grained values of the readings and only learns from what can be deduced from the final bill. The aggregators also do not see any individual values. The request merely asks for the keys associated with the corresponding set of meters.

At 440, the computing device 302 determines whether there are more billing operations to perform. If there are, then the protocol returns to billing operations 430 for calculating more billing information. This protocol does not require performing additional setup operations. If there are no more billing operations to perform, then the protocol continues to 450 for the next check.

At 450, the computing device 302 determines whether there are more aggregation operations to perform. If there are, then the protocol returns to aggregation operations 420 to calculate more aggregate statistics. The protocol does not require performing additional setup operations to perform additional aggregation operations. If there are no more aggregation operations to perform, then the protocol continues to 460. In some embodiments, after operations for obtaining all the aggregate statistics and or billing information are determined, the desired information may be provided and analyzed where the aggregated statistics and/or billing information is generated and used as desired by the service provider 250.

At 460, the aggregated statistics may be used by the service provider 250. For example, in the case of smart metering, the service provider 250 may use the aggregated statistics to diagnose the location of failure in a grid, average usage for an area for a certain time period, etc. The aggregate statistics may be used to improve the process or for any purpose desired by the service provider 250. For example, in the case of billing, the billing information may be provided to the customer via any means such as through the Internet, telephone service (POTS) or the postal system.

In further embodiments, a portion of the statistical information is obtained and provided as they become available before the collection and determination of aggregation operations 420 and billing operations 430 are complete.

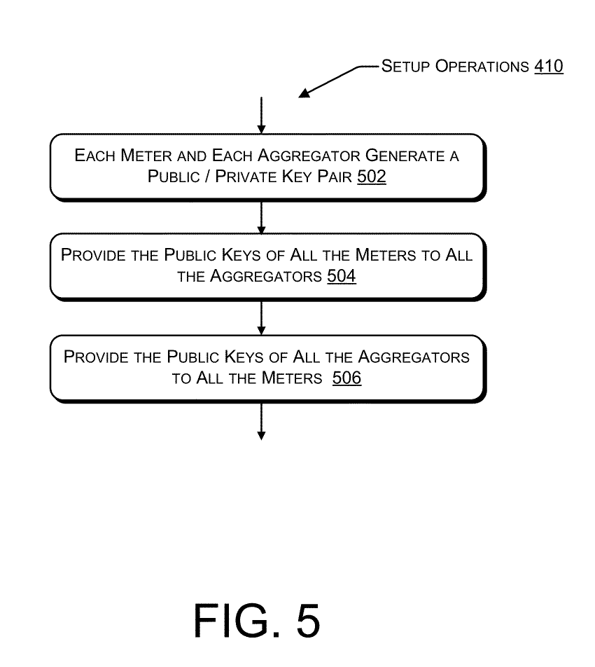

FIG. 5 illustrates an example process for setup operations 410, in accordance with various embodiments. The setup operations 410 configure the system to perform aggregation operations 420 and billing operations 430 without performing the setup operations 410 again.

At 502, each meter and each aggregator generate a shared secret such as a public/private key pair. The generation of the key pairs may use any known methods. In an embodiment, the generation is done using the Diffie-Hellman crypto system. In other embodiments, the keys may be provided by the trust authority. Any secure mechanism, including a certificate chain, an auditing mechanism or factory initialization can be used.

At 504, the public keys of all the meters 110 are derived by the aggregators 160. In some embodiments, the public keys generated for each aggregator 160₁, 160₂ . . . 160_{N1} are transmitted to all the meters 110 from the trusted authority. In some embodiments, each aggregator 160₁, 160₂ . . . 160_{N1} derives a shared key with a corresponding meter 110₁, 110₂ . . . 110_{N1}. In some embodiments, the number of meters and number of aggregators are not the same. In other embodiments, the number of meters equals the number of aggregators. Any number of meters and aggregators may be utilized in this system. After the shared key has been generated, a secret value is generated and stored. Each aggregator 160₁, 160₂ . . . 160_{N1} stores each key and/or secret value. This information may be stored in one or more computer-readable media.

At 506, the public keys of all the aggregators 160 are derived by the meters 110. In some embodiments, the public keys generated for each aggregator 160₁, 160₂ . . . 160_{N1} are transmitted to all the meters 110 from the trusted authority. In various embodiments, additional encryption and/or encoding may be used in the transmission of the keys. In some embodiments, a key of each aggregator 160₁, 160₂ . . . 160_{N1} is derived by each meter 110₁, 110₂ . . . 110_{N1}. In some embodiments, the number of meters and number of aggregators are not the same. In other embodiments, the number of meters equals the number of aggregators. Any number of meters and aggregators may be used in this system. Each meter 110₁, 110₂ . . . 110_{N1} may store each key in one or more computer-readable media.

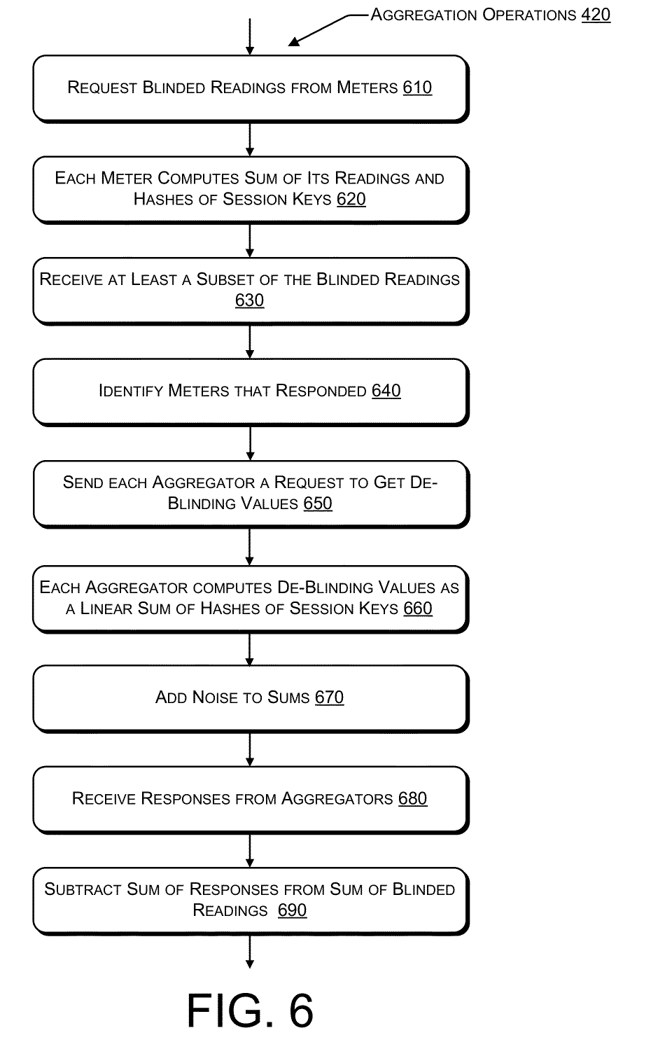

FIG. 6 illustrates an example process for aggregation operations 420, in accordance with various embodiments. The service provider 250 may request aggregate statistics for any purpose. The protocol provides added privacy and security for fine grade information collected by the meters 110.

At 610, a service provider 250 requests blinded readings from a time period for a group of meters 100. The service provider 250 may transmit the request over the network 150 to the meters 110.

At 620, each meter that receives the request computes a sum of its readings for that time period and all the session keys of the aggregators 160. The meters may obtain and provide the aggregate readings with the time period as specified in the request using any means of the smart meters. To provide additional privacy, the meters blind the readings by combining each reading with all the keys of the aggregators 160. In some embodiment, a hash of the keys is used for calculating the blinded readings. In the implementation with smart meter, the result maybe modulated to form a 32-bit binary integer because 32 bits are the establish protocol for smart meter transmission. However, the result may be modulated into any format equivalent to the 32 bits per reading to provide transmission of the result in the transmission protocol of the system.

At 630, the service provider 250 receives a subset of the blinded readings. In certain situations, the subset may include all the meters 110. In other situations, the subset may include less than all the meters in the set of meters. Some of the blinded readings requested by the service provider 250 may not be received by the service provider 250. The missing readings may be dues to any known or unknown reasons including meter malfunction, network unavailability or latency.

At 640, the service provider 250 identifies meters that responded to the request for readings. The identified meters may be the set of all the meters whose blinded readings were received. The identified meters may be the subset of blinded readings that was requested. In other words, the service provider 250 will know which meters have responded based at least in part on the responses that have been received.

At 650, the service provider 250 sends each aggregator a request for de-blinding value. The service provider 250 does not provide any values of the individual meter readings to the aggregators 160. The service provider 250 may transmit the information of the identified meters to the aggregators. In some embodiments, the information may include the meters that responded to the aggregator. The information may also include the time period information. The aggregators may receive the request for de-blinding values of the subset of the meters.

At 660, each aggregator computes a linear sum. In some embodiments, each aggregator may utilize the meter identifying information to calculate the linear sum. In other embodiments, the time period information may be also used. For example, the linear sum may be calculated by summing all the session keys that correspond to the identified meters. The result may be modulated into a 32-bit binary number.

Optionally, at 670, noise may be added to the linear sum computed at 660 to result in the de-blinding value. The noise may be selected to increase the privacy of the protocol. In some embodiments, the noise is a value added to linear sum to offer differential privacy based at least in part on the sensitivity of a one or more readings.

At 680, the service provider 250 receives the responses from aggregators. In some embodiments, the responses include the de-blinding value. In other responses, the response may be the de-binding value transmitted in the form having 32-bits binary value. Additional secure mechanism may be used for the transmission of the de-blinding value.

At 690, the service provider 250 subtracts the sum of the de-blinding values from the sum of blinded readings. The value from this subtraction is the aggregate statistics of the requested aggregate readings from the subset of meters. The aggregate statistics may be used for statistical analysis.

In other embodiments, the meters may subtract the blinding values instead of performing the addition of 620 and the service provider 250 may then adds the de-blinding values instead of performing the subtraction of 690 to recover the blinded readings.

FIG. 7 illustrates an example process for billing operations 430, in accordance with various embodiments. In various embodiments, the service provider 250 may want to do time-of-use billing for a specific set of meter readings belonging to a single customer.

At 710, the service provider 250 requests multiple readings from a single customer or meter. The multiple readings may be for a specific time period of the billing such usage for a month.

At 720, the meter of the customer computes a sum of the readings for the desired time period and all session keys of the aggregators 160. In some embodiments, the time period may be one month. In other embodiments the period may be two months or one year. Any time period may be used depending on the requirements of the billing procedure.

At 730, the service provider 250 receives the blinded readings from the meter. At 740, the service provider 250 sends each aggregator a request to get a corresponding de-blinding value for the meter. In some embodiments, the service provider 250 may identify the meter that provided the blinded readings. In other embodiments, additional information may be provided such as reading types or rates.

At 750, each aggregator computes a linear sum using the information provided. In some embodiments, the linear sum is computed with the time dependent rate and the hash of the secure key of the meter for every aggregator. The linear sum may be computed with any methods as long as it can de-blind the blinded reading.

At 760, the service provider 250 receives the de-blinding value from aggregators. At 770, the service provider 250 subtracts the sum of the de-blinding value from the sum of the blinded readings to get the value for the meter for the time period as specified. With this information, the client may be billed for the usage of a specific period of time as desired. Security and privacy guarantee is that the service provider 250 only learns what can be deduced from the final bill.

In other embodiments, the meter may subtract the blinding values instead of performing the addition of 720 and the service provider 250 may then adds the de-blinding values instead of performing the subtraction of 770 to determine value for the bill.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A system comprising:
one or more processors;
a memory coupled to the one or more processors to store:
a setup module configured to generate public keys for a plurality of meters and aggregators, provide the public keys of the plurality of meters to the plurality of aggregators, and provide the public keys of the plurality of aggregators to the plurality of meters; and
an aggregation module configured to:
receive blinded readings from one or more of the meters;
receive a plurality of de-blinding values corresponding to the plurality of aggregators, each de-blinding value being a sum of one or more representations of keys corresponding to the one or more meters; and
recover an aggregated reading based at least in part on an aggregation of the de-blinding values and an aggregation of the blinded readings.

2. The system of claim 1, further comprising a billing module configured to:
receive a blinded reading from one of the meters;
receive a plurality of de-blinding values corresponding to the plurality of aggregators, each de-blinding value being a representation of a key corresponding to the meter;
subtract an aggregation of the de-blinding values from the blinded reading to recover a reading of the meter; and
utilize the reading for billing.

3. The system of claim 1, wherein the one or more of the meters are a subset of the plurality of meters, and the aggregation module is configured to request readings from the plurality of meters.

4. The system of claim 1, wherein each of the blinded readings is determined by a sum of a reading and hashes of session keys derived from shared keys, each shared key specific to a pair of the meter producing the reading and one aggregator of the plurality of aggregators, each shared key in turn derived from the public keys of the meter and the aggregator of the pair.

5. A computer-implemented method comprising:
requesting readings from a plurality of meters;
receiving blinded readings from at least a subset of the meters;
identifying the subset of the meters from which blinded readings were received;
requesting a plurality of de-blinding values from a corresponding plurality of aggregators, each de-blinding value being a sum of one or more representations of keys corresponding to the subset of the meters;
receiving the de-blinding values; and
subtracting an aggregate of the de-blinding values from an aggregate of the blinded readings to recover an aggregated reading.

6. The method of claim 5, wherein each of the blinded readings is determined by a sum of a reading and representations of the keys shared by the meter producing the reading and the plurality of aggregators.

7. The method of claim 5, wherein the one or more representations of keys are hashes of session keys derived from shared keys being specific to a pair of one meter and one aggregator, the shared keys in turn being derived from an exchange of public keys of the one meter and the one aggregator.

8. The method of claim 5, wherein the plurality of de-blinding values include corresponding noise values added to the sums of the representations of the keys.

9. The method of claim 5 further comprises auditing and comparing the requests for the readings against a privacy policy.

10. The method of claim 5, further comprising determining aggregate statistics associated with aggregated readings from multiple time periods.

11. The method of claim 5, further comprising exchanging public keys between the one or more meters and the plurality of aggregators, including providing a public key of each meter to each aggregator and providing a public key of each aggregator to each meter.

12. One or more tangible computer-readable media storing a plurality of executable instructions configured to program a computing device to perform operations comprising:
receiving blinded readings from one or more meters;
receiving a plurality of de-blinding values from a corresponding plurality of aggregators, each de-blinding value being a sum of one or more representations of keys corresponding to the one or more meters; and
recovering an aggregated reading based at least in part on an aggregation of the de-blinding values and an aggregation of the blinded readings.

13. The tangible computer-readable media of claim 12, wherein each of the blinded readings is determined by a sum of a reading and representations of the keys shared by the meter producing the reading and the plurality of aggregators.

14. The tangible computer-readable media of claim 12, wherein the one or more representations of keys are hashes of session keys derived from shared keys being specific to a pair of one meter and one aggregator, the shared keys in turn being derived from an exchange of public keys of the one meter and the one aggregator.

15. The tangible computer-readable media of claim 12, wherein the plurality of de-blinding values include corresponding noise values added to the sums of the representations of the keys.

16. The tangible computer-readable media of claim 12, wherein the operations further comprise auditing and comparing requests for readings against a privacy policy, the blinded readings being received responsive to the requests for readings.

17. The tangible computer-readable media of claim 12, wherein the operations further comprise determining aggregate statistics associated with aggregated readings from multiple time periods.

18. The tangible computer-readable media of claim 17, wherein determining the aggregate statistics further comprises calculating a mean or variance of the aggregate readings.

19. The tangible computer-readable media of claim 12, wherein the operations further comprise applying a time dependent rate to the blinded readings.

20. The tangible computer-readable media of claim 12, wherein the operations further comprise exchanging public keys between the one or more meters and the plurality of aggregators, including providing a public key of each meter to each aggregator and providing a public key of each aggregator to each meter.
